(19) United States
(12) Patent Application Publication
(10) Pub. No.: US 2004/0124370 A1
(43) Pub. Date: Jul. 1, 2004

(54) Process and system for curing clearcoats

(76) Inventors: John Gerlock, Dearborn, MI (US); Mark Nichols, Saline, MI (US); Christopher Seubert, Livonia, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/735,536

(22) Filed: Dec. 12, 2003

Related U.S. Application Data
(60) Provisional application No. 60/432,973, filed on Dec. 13, 2002.

(51) Int. Cl. G21G 5/00

(52) U.S. Cl. 250/492.1

(57) ABSTRACT

In at least one embodiment, the present invention comprises a method for curing a UV curable clearcoat composition. The method comprising providing an article and applying a UV curable clearcoat composition to the article. The method further comprises exposing the UV curable clearcoat composition to a first light source having a first average light intensity for a first period of time, which is sufficient to cure a first portion of the UV curable clearcoat composition, and exposing the UV curable clearcoat composition to a second light source having a second average light intensity less than the first average intensity for a second period of time which is sufficient to cure a second portion of the UV curable clearcoat composition. The first and second portions form a cured clearcoat. In at least one embodiment, a system for curing a UV curable clearcoat composition is also provided.

### CROSS-REFERENCE TO RELATED APPLICATIONS

This application claims the benefit of U.S. Provisional Patent Application Serial No. 60/432,973, filed Dec. 13, 2002, which is incorporated herein by reference.

### BACKGROUND OF THE INVENTION

1. Field of the Invention

In at least one embodiment, the present invention relates to a method for curing a UV curable clearcoat.

2. Background Art

One of the determining factors influencing a consumer's decision to purchase vehicles is the appearance of a vehicle. As such, the finishing, or painting, of a vehicle is an important aspect of the automotive process. Current finishing technologies typically involve the application of four organic paint layers on top of phosphated and galvanized steel. The top two layers, the base coat and the clear coat, provide the high gloss colored/metallic appearance of today's vehicles.

The chemistry of both the base coat and clearcoats are typically based on either water borne or solvent borne thermally cured resins, with acrylic-melamine or polyurethane being the two most common classes of coatings used today. Increasingly stringent environmental regulations are driving automotive manufacturers to seek alternative methods for painting vehicles. In particular, stricter volatile organic compound (VOC) limits have been mandated, which has caused the industry to explore different coating technologies that can provide lower or zero VOC's.

UV curable coatings have been explored as one such alternative low or zero VOC coating technology. UV curing offers the advantages of, among other things, low or potentially zero VOC's, relatively very short (potentially only a few seconds) curing times, and relatively very high cross-link densities (given rise to outstanding scratch resistance). All of these properties are attractive to the automotive industry.

The main constituents of a UV curable clearcoat include multifunctional oligomers, reactive diluents or monomers, photoinitiators and various light stabilizers. UV curable clearcoats use free radical initiation as the mechanism of curing. Curing reactions are induced by absorption of high intensity UV light by the photoinitiator, and subsequent free radical polymerization and cross-linking of the resins (oligomers and monomers).

It is well known that atmospheric oxygen makes it difficult to cure UV curable clearcoats because oxygen is an excellent scavenger for both the initiator and the polymer radicals. Traditional remedies for this problem include employing a very fast cure using high intensity, short wavelengths, the use of a nitrogen blanket to eliminate oxygen from the atmosphere around the clearcoat during the cure, and the use of a surface wax as a barrier between the clearcoat and the atmospheric oxygen. These traditional remedies have certain drawbacks.

In order to produce the short cure time, high intensity cure, high intensity UV lamps (such as on the order of about 70 W/m² at 335 nm at distances of about 15 cm) are used to cure the clearcoats. However, these high intensity lamps produce ozone, which can be hazardous in a manufacturing environment. Furthermore, while the speed of cure tends to always be important in automotive applications, it is typically not necessary to cure these clearcoats in less than one second for automotive applications. The use of a nitrogen blanket and the surface wax involves an extra step that can cause safety and/or workability issues, which can result in additional time and costs expenditures.

Accordingly, it is desirable, and a need exists, to provide a method of painting a UV curable clearcoat that overcomes at least one of the deficiencies in the prior art.

### SUMMARY OF THE INVENTION

At least one aspect of the present invention relates to a method of curing a UV curable clearcoat composition. The method comprises providing an article, applying a clearcoat composition to the article, exposing the UV curable clearcoat composition to a first light source having a first average light intensity for a period of time sufficient to cure a first portion of the UV curable clearcoat composition, and exposing the UV curable clearcoat composition to a second light source having a second average light intensity, less than the first average light intensity, for a period of time sufficient to cure a second portion of the UV curable clearcoat composition.

In at least one embodiment, the first portion of the clearcoat composition is substantially the upper 25% of the total thickness of the clearcoat composition. In at least another embodiment, the second portion of the UV curable clearcoat is the lower 75% of the total thickness of the UV curable clearcoat composition.

In at least one embodiment, the amount of energy required to cure the first portion of the UV curable clearcoat composition comprises 75-300 J/m² at 320 nm (nanometers). In certain embodiments, this energy dosage is provided in less than 2 minutes.

In certain embodiments, the first light source is delivered in a pulsed manner. In certain embodiments, when the first light source is delivered in a pulsed manner, about 2-12 J/m² at 320 nm of energy, and in other embodiments 4-10 J/m², is being delivered per pulse. In this embodiment, the pulse length can be 0.5 to 2.0 milliseconds (msec) and can be repeated about every 0.001-2.0 seconds. In some embodiments, the average intensity of the first light source is 0.1-100.0 W/m² at 260-400 nm at a distance of 15 cm.

In at least one embodiment, the first light source is delivered from a xenon flash lamp. This first light source, delivered at a relatively high intensity and over a relatively short time period, can provide a significant level of curing (at least 80%) in the first portion of the clearcoat coating composition to inhibit the effect of the oxygen scavenging the UV curable clearcoat.

In at least one embodiment, the second light source provides 50-100 J/m² at 380 nanometers (nm) of energy. In certain embodiments, the length of the second cure comprises between 10-30 minutes. In certain embodiments, the intensity of the second light source is 0.01-1.0 W/m² at 300-400 nm at 15 cm.

It should be understood that the amount of energy could vary if different wavelengths and/or distances are used than those identified above.

### BRIEF DESCRIPTION OF THE DRAWINGS

FIG. 1 is a cross sectional view of a typical painted metal substrate; and

FIG. 2 is a schematic flow diagram representing the process for painting an article in accordance with an embodiment of the present invention.

### DETAILED DESCRIPTION OF THE PREFERRED EMBODIMENT(S)

As required, detailed embodiments of the present invention are disclosed herein. However, it is to be understood that disclosed embodiments are merely exemplary of the invention that may be embodied in various alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention. Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of”, and ratio values are by weight and the description of a group or class of materials as suitable or preferred for a given purpose in connection with the invention implies that mixtures of any two or more members of the group or class may be equally suitable or preferred.

The present invention relates to a method of curing a UV curable composition applied to an article or substrate. It is contemplated that any paintable substrates can be coating with any suitable UV curable clearcoat in accordance with the present invention. Examples of articles/substrates that can be coated in accordance with the present invention, include, but are not necessarily limited to, metallic and plastic articles/substrates.

The present invention will be described in connection with applying a UV curable clearcoat to a vehicle however, it is to be understood that articles other than vehicles can be coated in accordance with the present invention.

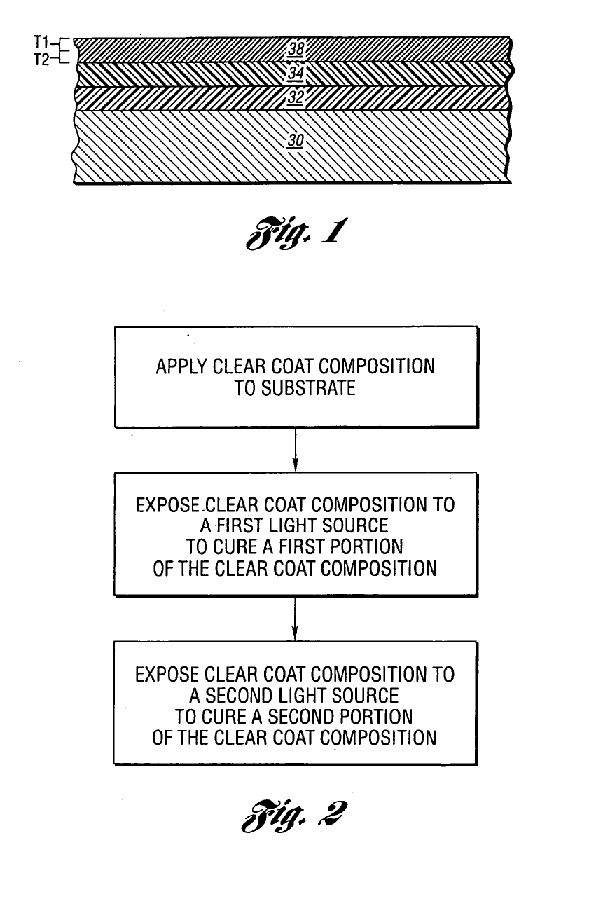

FIG. 1 represents a cross-section of a vehicle UV clearcoated in accordance with the present invention. A substrate 30, which in this embodiment is a portion of a vehicle, is coated with a cured primer coat 32. As is readily understood by those of ordinary skill in the art, between the primer coat 32 and the substrate 30 could be known processing coatings such as an e-coat and/or a phosphate coat, or the substrate could be formed from a pre-coated metal or plastic material. Above the primer coat 32 is a base coat 34. Over the base coat 34 is a clearcoat 38. Each of the coats described and illustrated in FIG. 1 are cured.

The primer coat 32, base coat 34 and UV curable clearcoat 38, can be formed from any suitable compositions and applied in any suitable method known to those or ordinary skill in the art. In the most common embodiment, the coats will be applied by spraying corresponding compositions onto the substrate or the preceding coat or composition, as the case may be.

FIG. 2 illustrates a method for curing a UV curable clearcoat composition in accordance with at least one aspect of the present invention. A UV curable clearcoat composition is applied to the substrate 30. In at least one particular preferred embodiment, as shown in FIG. 2, the substrate 30 will have a cured primer coat 32 and a cured base coat 34 between the metal substrate 30 and the UV curable clearcoat composition. The clearcoat composition can be applied in a one- or two-step process. The clearcoat composition can be applied in any suitable manner known to those of ordinary skill in the art. In the most common embodiment, the clearcoat composition is applied via spraying. Any suitable UV curable clearcoat composition known to one or ordinary skill in the art can be used. Suitable UV curable clearcoat compositions comprise multifunctional acrylates, available from UCB of Smyrna, Ga.

After the UV curable clearcoat composition has been applied, the UV curable clearcoat composition is exposed to a first light source to cure a first portion of the UV curable clearcoat composition. In at least one embodiment, the first portion of the UV curable clearcoat composition that is cured via exposure to the first light source comprises 3-25% of the total thickness of the UV clearcoat 38, in other embodiments 5-15% of the total thickness of the UV clearcoat 38, and in yet other embodiments 10% of the total thickness of the UV clearcoat 38.

The first light source comprises a relatively high intensity light source. In at least one embodiment, the first light source is capable of providing an energy dosage to the UV curable clearcoat composition in an amount of 75-300 J/m² (joules per meter squared) at 320 nm (nanometers), in other embodiments 100-225 J/m² at 320 nm, and in yet other embodiments 200 J/m² at 320 nm. This dosage is delivered over a relatively short time period in order to prevent at least a substantial portion the oxygen in the atmosphere from scavenging the photoinitiator or the polymeric/oligomeric free radicals in the UV curable clearcoat composition. This short time period, in at least one embodiment, comprises more than 0.5 seconds and less than 120 seconds, in other embodiments between 5 and 90 seconds, in yet other embodiments between 15 and 45 seconds, and still yet in other embodiments 30 seconds. In at least one embodiment, the average intensity of the first light source is, at 260-400 nm at a distance of 15 cm, between 0.1-100 W/m² (watts per meter squared), in other embodiments between 0.5-25 w/m², in yet other embodiments between 2 and 10 W/m², and in still yet other embodiments between 3 and 8 W/m^{2.}

The first light source can be supplied in a continuous manner for the short time period or it may be supplied in a discontinuous, i.e. flashed, manner during the short time period. If the first light source is to be provided in flashed manner, in at least one embodiment, the length of the flash will be between 0.5-2.0 milliseconds (msec), and in other embodiments 0.90-1.15 milliseconds, with each flash being spaced apart, in at least one embodiment, for a period of 0.001-2.0 seconds, and in other embodiments for 0.9-1.15 seconds.

The preferred source of the first light source is UV radiation with emissions in the wavelength range from 180 to 420 nm, particularly from 260 to 400 nm. Examples of such UV radiation sources include optionally doped mercury high pressure, medium pressure and low pressure radiation emitters, gas discharge tubes such as xenon or krypton low pressure lamps, metal halide bulbs, and UV lasers. In at least one preferred embodiment, a xenon or krypton flash lamp is particularly preferred, with the xenon flash lamp being more preferred. A particularly preferred xenon flash lamp comprises the VISIT xenon flash lamp available from VISIT GmbH & Company, of Wurzburg, Germany.

After the first portion of the UV curable clearcoat composition has been cured, the remainder, i.e. a second portion, of the UV curable clearcoat composition is exposed to a second light source to complete the curing of the clearcoat composition. The second light source has a significantly lower intensity than the first light source. In at least one embodiment, the average intensity of the second light source, at 300-400 nm at a distance of 15 cm, comprises 0.001-0.10 W/m² (watts per meter squared), in other embodiments 0.03-0.075 W/m², and in yet other embodiments 0.05 W/m². In certain embodiments, the average intensity of the first light source is between 25 and 100 time more than the average intensity of the second light source, more preferably between 40 and 75 times the intensity of the second light source, and most preferably between 50 and 65 times the intensity of the second light source.

The second light source is, in at least one embodiment, a diffused light source that can complete the cure of the UV curable clearcoat composition in a relatively slow manner and also reduces the effects of shading on three-dimensional objects, such as vehicles. The amount of energy required for the second cure from the second light source, in at least one embodiment, comprises 50-100 J/m² at 380 nm, in other embodiments 60-85 J/m² at 380 nm in yet other embodiments 75 J/m² at 380 nm. It should be noted that the energy required for the curing of the first portion of the UV curable clearcoat composition and the curing of the second portion of the UV curable clearcoat compositions can vary depending upon the specific compositions employed, and the distance at which the light sources are maintained from the substrate or UV clearcoat composition and the wavelength employed. The amount of time that the second light source is exposed to the UV curable clearcoat composition may also vary, but in at least one embodiment comprises 2-45 minutes, in other embodiments 5-30 minutes and in yet other embodiments 10-20 minutes.

In at least one embodiment, the preferred source of the second light source is UV radiation with emissions in the wavelength range from 300 to 420 nm, and in other embodiments from 300 to 400 nm. Examples of such UV the second light source, i.e. the diffuse light source, in at least one preferred embodiment, comprises flourescent lighting. Other types of relatively low intensity light sources can be used in addition to or in lieu of flourescent lighting, these sources include, but are not necessarily limited to, UV point source radiation emitters such as, UV-emitting diodes and black light tubes, metal halide bulbs, and UV-LEDs.

As shown in FIG. 1, the first light source cures a first portion T1 of the clearcoat 38 while the second light source cures the second portion T2 of the clearcoat 38. In at least one embodiment, the first portion comprises 5-25% of the entire thickness of the clearcoat, in other embodiments 10-20%, and in yet other embodiments 10%, with the second portion comprising the remainder of the clearcoat. In at least one embodiment, the amount of energy required to cure the first portion T1 of clearcoat 38 comprises 40-85% of the total energy required to cure the clearcoat, and in other embodiments at least 50%, and in still other embodiments 60-80%.

In another embodiment, a system, or paint line, is provided for practicing the present invention. In at least one embodiment, the system comprises a spraying unit, such as spray stations with spray guns as are conventionally used in vehicle paint spraying processes, for applying a UV curable clearcoat composition to the article, such as a vehicle. The system, in at least one embodiment, comprises a first light source, such as a lighting chamber, for exposing the first light source to the UV curable clearcoat, and a second light source, such as a diffuse lighting chamber, for exposing the UV curable clearcoat composition to the second light source. In certain embodiments, the light sources can be in the same chamber, sequentially spaced, and in other embodiments, can be separate chambers. The system can also comprise a transporting unit, such as a rail as is conventionally known in the vehicle and/or other painting processes, for transporting the article through the spraying unit and the first and second light sources.

The practice of this invention may be further appreciated by consideration of the following, non-limiting examples, and the benefits of the invention may be appreciated by the examples set forth below.

### EXAMPLES

### Example 1

A 50 micron UV curable clearcoat composition multi-functional acrylates from UCB of Smyrna, Ga. was applied to a cold rolled steel substrate. The UV curable clearcoat composition on the substrate was exposed to flourescent lighting at a dosage of 75 J/m² at 380 nm at an intensity of 0.05 W/m² for a period of 15 minutes. The percent cure of the UV curable clearcoat composition was measured at two different portions of the clearcoat. A first portion comprising about 5 microns constituted the top (T) of the clearcoat while the remaining about 45 microns represented the bottom (B) portion of the clearcoat. Using the known Raman technique to measure the degree of cure in the UV curable coating, as set forth in “A Simple Raman Technique To Measure The Degree Of Cure In UV Curable Coatings” Process In Organic Coatings 43 (2001) 226-232, it was determined that the top portion of the clearcoat had a 65% cure while the bottom portion had a 87% cure. These cure values are not acceptable for commercial use.

### Example 2

The UV curable clearcoat composition similar to the composition of Example 1 was exposed to 5 flashes of 1.5 msec length of a VISIT xenon lamp having an average intensity of about 8 W/m² at a wavelength of 320 nm at a distance of 15 cm. The percent cure of both the top and bottom portions of the UV curable clearcoat were determined to be 30%. These cure values are not acceptable.

### Example 3

The UV curable clearcoat composition similar to the composition of Example 1 was exposed to 25 flashes of the VISIT xenon lamp of the same intensity, duration, and conditions as in Example 2. The top of the clearcoat was determined to have a 80% cure while the bottom of the clearcoat was determined to have a 82% cure. These cure values are not acceptable for commercial use.

### Example 4

The UV curable clearcoat composition similar to the composition of Example 1 was exposed to 5 flashes of the VISIT xenon flash lamp of the same intensity, duration, and conditions as in Example 2. The UV curable clearcoat composition was then exposed to flourescent lighting of the same intensity, duration, and conditions as in Example 1. The top of the clearcoat was measured to have a 78% cure percent while the bottom of the clearcoat was measured to have a 85% cure rate. The percent cure of the top portion of the clearcoat is unacceptable rendering the entire clearcoat unsuited for commercial use.

### Example 5

The UV curable clearcoat composition similar to the composition of Example 1 was exposed to 25 flashes of the VISIT xenon flash lamp of the same intensity, duration, and conditions as in Example 2. The UV curable clearcoat composition was then exposed to flourescent lighting of the same intensity, duration, and conditions as in Example 1. The top of the clearcoat was measured to have a 88% cure percent while the bottom of the clearcoat was measured to have a 89% cure rate. These cure values are acceptable for commercial use.

While the best modes for carrying out the invention has been described in detail, those familiar with the art to which this invention relates will recognize various alternative designs and embodiments for practicing the invention as defined by the following claims. For instance, it should be obvious to those familiar with the art that modifications to the distance, and intensities, and wavelength can be modified and still practice the spirit and scope of the present invention.

What is claimed:

1. A method for curing a UV curable clearcoat composition, said method comprising:
providing an article;
applying a UV curable clearcoat composition to the article;
exposing the UV curable clearcoat composition to a first light source having a first average light intensity for a first period of time which is sufficient to cure a first portion of the UV curable clearcoat composition; and
exposing the UV curable clearcoat composition to a second light source having a second average light intensity less than the first average intensity for a second period of time which is sufficient to cure a second portion of the UV curable clearcoat composition, the first and second portions forming a substantially cured clearcoat.

2. The method of claim 2 wherein the first portion comprises 5 to 25 percent of the UV curable clearcoat composition and the second portion comprises the remainder of the UV curable clearcoat composition.

3. The method of claim 2 wherein the first portion is above the second portion.

4. The method of claim 1 wherein the first source comprises a xenon flash lamp.

5. The method of claim 4 wherein the second source comprises a flourescent difuse lighting source.

6. The method of claim 1 wherein the amount of energy required to cure the first portion comprises 75-300 J/m² at 320 nm.

7. The method of claim 1 wherein the amount of energy required to cure the second portion comprises 50-100 J/m² at 380 nm.

8. The method of claim 2 wherein the first portion require at least 50% of the total energy required to cure the entire clearcoat composition.

9. The method of claim 1 wherein the first period of time comprises 15-45 seconds.

10. The method of claim 1 wherein the second period of time comprises 10-20 minutes.

11. The method of claim 9 wherein the first average intensity comprises 0.1-100 W/m² at 260-400 nm at a distance of 15 cm.

12. The method of claim 1 wherein the second intensity comprises 0.01-1.0 W/m² at 300-400 nm at a distance of 15 cm.

13. The method of claim 11 wherein the first light source is a discontinuous light source.

14. The method of claim 13 wherein the first light source is delivered in spaced apart flashes of light.

15. A method for curing a UV curable clearcoat composition, said method comprising:
providing an article;
applying a UV curable clearcoat composition to the article;
exposing the UV curable clearcoat composition to a first light source supplying 75-300 J/m² at 320 nm of energy to cure a first portion of the UV curable clearcoat composition; and
exposing the UV curable clearcoat composition to a second light source supplying 50-100 J/m² at 380 nm of energy to cure a second portion of the UV curable clearcoat composition, the first and second portions forming a substantially cured clearcoat.

16. The method of claim 15 wherein the first portion comprises 5 to 25 percent of the UV curable clearcoat composition, the second portion comprises the remainder of the UV curable clearcoat composition, with the first portion being above the second portion.

17. The method of claim 15 wherein the first source comprises a xenon flash lamp.

18. The method of claim 17 wherein the second source comprises a flourescent difuse lighting source.

19. A system for curing a UV curable clearcoat composition on an article, said system comprising:
a spray unit for applying a UV curable clearcoat composition to the article;
a first light unit for exposing the UV curable clearcoat composition to a first average light source having a first average light intensity for a first period of time which is sufficient to cure a first portion of the UV curable clearcoat composition;
a second light unit for exposing the UV curable clearcoat composition to a second light source having a second average light intensity less than the first average intensity for a second period of time which is sufficient to cure a second portion of the UV curable clearcoat composition, the first and second portions forming a substantially cured clearcoat; and
transport unit for transporting the article through the spray unit, the first light unit, and the second light unit.

20. The system of claim 19 wherein the first source comprises a xenon flash lamp, and the second source comprises a flourescent difuse lighting source.
